(19) United States
(12) Patent Application Publication
(10) Pub. No.: US 2024/0424687 A1
(43) Pub. Date: Dec. 26, 2024

(54) DEVICE AND METHOD FOR DETERMINING, IN AT LEAST THREE SPATIAL DIRECTIONS, A FORCE ACTING ON A BODY

(71) Applicant: NEURA ROBOTICS GMBH, Metzingen (DE)

(72) Inventors: Yitao DING, Reutlingen (DE); Eamon BARRETT, Reutlingen (DE)

(21) Appl. No.: 18/753,654

(22) Filed: Jun. 25, 2024

(30) Foreign Application Priority Data
Jun. 26, 2023 (DE) 202023103525.6

(51) Int. Cl. B25J 13/08; B25J 13/06; G01L 5/16

(52) U.S. Cl. CPC B25J 13/085; B25J 13/065; G01L 5/16

(57) ABSTRACT

A device for determining, in at least three spatial directions, a force acting on a body, in particular a manipulator, has two actuating elements. Each of the actuating elements has an operating element with a longitudinal axis which is movable, in particular tiltable, relative to a base element. An individual force is able to be determined, in at least three spatial directions, from the relative movement between the operating element and the base element. The two actuating elements are arranged relative to one another in such a way that the two operating elements are arranged on sides of the base elements facing away from one another. An evaluation/control unit records the individual force determined by each actuating element, and calculates, in at least three spatial directions, the force acting on the body from the two individual forces, in particular, from the sum of the individual forces.

The invention relates to a device for determining, in at least three spatial directions, a force acting on a body and a body having such a device.

To program and to set up bodies, in particular manipulators such as, for example, industrial robots or cobots, such bodies must be moved manually by applying a force to the body itself or to a corresponding input device on the body. In many applications, the sensitivity or delicacy of the respective input device for executing the movement is a limiting factor. In addition, due to the measuring principle for detecting a force, current solutions have a sensitivity that depends on the position of the body.

Since manipulators often have various degrees of freedom, simultaneously controlling all these axes in interpolated Cartesian movements in all six degrees of freedom (X, Y, Z, Ry, Ry, Rz) is of great importance in order to make the programming process fast and intuitive.

It is currently known to measure the motor currents required to move individual axles of a body, in particular a manipulator, and to calculate therefrom the torques present on the axles. By subtracting the required holding torques, changes caused by forces applied to the axes can be calculated and converted into subsequent movements. The disadvantage here, however, is that the forces applied to the body are measured only indirectly. Depending on the position of the body, in particular the manipulator, leverage effects of different magnitudes can arise, which distribute the sensitivity of the solution in a non-homogeneous manner across the working space.

Alternatively, it is also known to measure the torques on the respective axles directly using torque sensors installed in the axles and to convert changes in the torque which are caused by forces applied to the axles into subsequent movements. A disadvantage of this method, however, is here also that the forces applied to the body are only measured indirectly and, depending on the position of the body, in particular the manipulator, different leverage effects can arise. In addition, torque sensors must be attached to each axle, which can lead to high costs.

The object of the invention is to provide a device for determining, in at least three spatial directions, a force acting on a body, by means of which the forces applied to the body can be recorded in such a way that a learning or programming process of the body is made possible in a simple way.

The object of the invention is achieved by a device for determining, in at least three spatial directions, a force acting on a body including the features of claim 1.

Advantageous embodiments and refinements of the invention are specified in the dependent claims.

The device according to the invention for determining, in at least three spatial directions, a force acting on a body, in particular a manipulator, has two actuating elements, each of the actuating elements having an operating element with a longitudinal axis which is movable, in particular tiltable, relative to a base element, an individual force being able to be determined, in at least three spatial directions, from the relative movement between the operating element and the base element, and the two actuating elements being arranged relative to one another in such a way that the two operating elements are arranged on sides of the base elements facing away from one another, and further comprises an evaluation/control unit, which records the individual force determined by each actuating element and which is designed to calculate, in at least three spatial directions, the force acting on the body from the two individual forces, in particular, from the sum of the individual forces. The actuation of such actuating elements can be carried out intuitively. Because the operating elements are arranged on sides of the base elements facing away from one another, a user can grip them in such a way that the thumb rests on one of the operating elements and, for example, the index finger rests on the other of the operating elements. In this way, the user can move the device in space and carry out a learning or programming process on the body simply by touching it.

In particular, the force acting on the body can be calculated at least in the three linear spatial directions X, Y, Z.

An individual force in at least four spatial directions can be advantageously determined from the relative movement between the operating element and the base element, in particular in the three linear spatial directions and in the direction of rotation about the longitudinal axis of the operating element, corresponding to the torque acting about the longitudinal axis of the operating element, whereby the accuracy of the determination of the force acting on the body can be increased.

The evaluation/control unit is advantageously designed to calculate, in six spatial directions, the force acting on the body from the two individual forces, in particular, from the sum of the individual forces, in order to further increase the accuracy of the determination of the force acting on the body.

The two base elements are preferably arranged at a distance A from one another other, which can enable the determination, in six spatial directions, of the force acting on the body, even if the two individual forces are determined in fewer spatial directions.

According to one preferred refinement of the invention, each of the actuating elements has an operating element with a longitudinal axis, which can be tilted relative to a base element. The tilting movements can be detected in a simple manner with high accuracy, while on the other hand the tilting movements can be carried out intuitively by a user, so that overall simple operation can result.

Advantageously, the actuating elements are designed in the manner of a joystick or trackpoint, which can enable simple and intuitive handling.

According to one preferred embodiment of the invention, it is provided that the evaluation/control unit is designed to calculate, in at least three spatial directions, the force acting between the two actuating elements based on the individual forces, in particular, from the difference between the individual forces. The additional determination of the force acting between the two actuating elements enables further applications.

In one preferred refinement, the device can, in particular, have a dead man's switch, which switches depending on the force acting between the two actuating elements. For this purpose, for example, the force acting between the two actuating elements can be compared with target values and, if the values are exceeded or not met, certain events can be triggered, for example preventing a movement of the body or activating a learning process or programming process.

In a single device, it is thus possible to implement both a control of a movement of the body based on the determination of the force acting on the body and, at the same time, a dead man's switch based on the determination of the force acting between the two actuating elements, both of which can be actuated with a single hand of the user.

According to one preferred embodiment of the invention, the actuating element, in particular the operating element, is coupled to an actuator, in particular a vibration motor. Such an actuator enables haptic feedback to the user, for example, about an actuation that has taken place, about movement limits of the body or about force or input limits, i.e., for example, an indication that the user is exerting too much force or torque or that the body can no longer move faster. In principle, it is also possible to provide different haptic feedback patterns in order to report different information back to the user.

A body according to the invention, in particular a manipulator, preferably an industrial robot or cobot, is equipped with a device according to the invention as described above. A cobot or collaborative robot is understood to mean an industrial robot that works together with people and is not separated from them by protective devices during the production process. Therefore, in particular for cobots, appropriate safety features are provided that make the interaction between the cobot and the user safe.

Preferably, the two actuating elements are arranged relative to one another on the surface of the body in such a way that their longitudinal axes are arranged parallel to one another. This can simplify the evaluation of the individual forces.

One advantageous refinement of the invention provides that the device is arranged detachably on the body, in particular in the form of a module. This enables retrofitting in a simple manner.

Preferably, the two actuating elements are arranged on two sides of the surface of the body facing away from one another in order to enable ergonomic gripping by a user.

Exemplary embodiments of the invention are explained in detail with reference to the following figures. In the figures

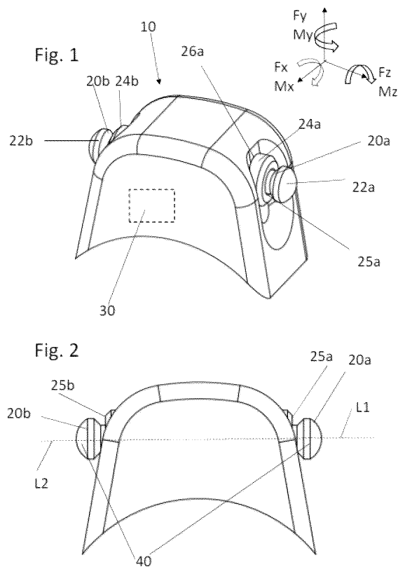

FIG. 1 shows a perspective view of an exemplary embodiment of a device according to the invention for determining, in at least three spatial directions, a force acting on a body,

FIG. 2 shows a plan view of the device according to FIG. 1,

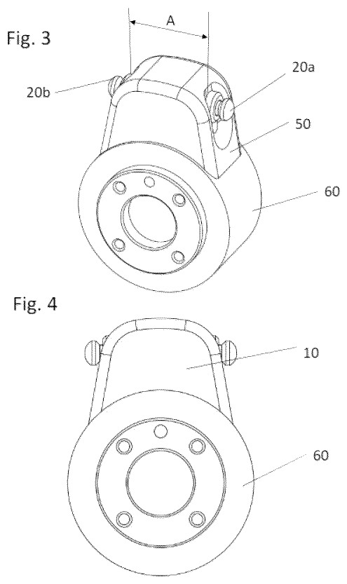

FIG. 3 shows a perspective view of the device according to FIG. 1 when arranged on a tool holder for a robot,

FIG. 4 shows a plan view of the arrangement according to FIG. 3,

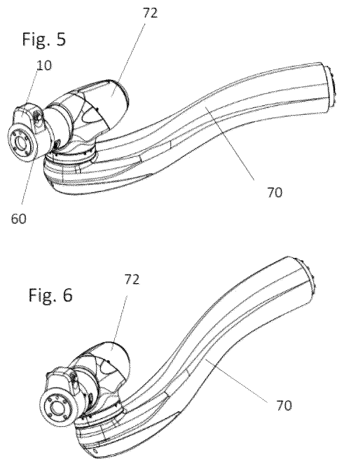

FIG. 5 shows a perspective view of a part of a robot arm with a device according to FIG. 1 arranged thereon,

FIG. 6 shows another perspective view of the part of the robot arm according to FIG. 5,

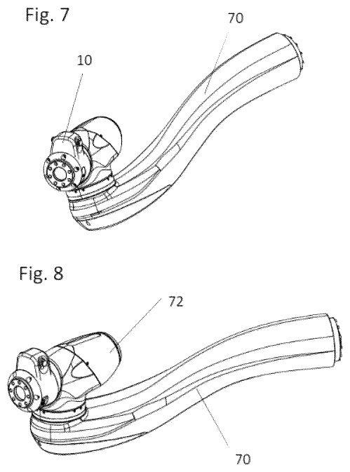

FIG. 7 shows a perspective view of a part of a robot arm with an integrated device for determining, in at least three spatial directions, a force acting on a body, and

FIG. 8 shows another perspective view of the part of the robot arm according to FIG. 7.

In all figures, identical reference numerals designate identical or functionally identical parts; for the sake of clarity, not all reference numerals are shown in all figures.

FIGS. 1 and 2 show an exemplary embodiment of a device 10 for determining, in at least three spatial directions Fx, Fy, Fz, Mx, My, Mz, a force acting on a body. The spatial directions are the three linear directions X, Y, Z and the rotation about these three linear directions. If the force acting on a body is determined in three spatial directions, it is, in particular, the three linear directions X, Y, Z. Preferably, the force acting on the body is determined in all six spatial directions Fx, Fy, Fz, Mx, My, Mz, that is to say, the linear forces Fx, Fy, Fz in the three directions X, Y, and Z, as well as the torques My, My, Mz about these three axes.

The device comprises two actuating elements 20a, 20b, wherein each of actuating elements 20a, 20b has an operating element 22a, 22b with a longitudinal axis L1, L2, which is movable, in particular tiltable, relative to a base element 24a, 24b. For example, each of the actuating elements 20a, 20b can be designed in the manner of a joystick or trackpoint. Each base element 24a, 24b has a first side 25a, 25b and a second side 26a arranged substantially parallel thereto, wherein the second side of second base element 20b is hidden in the figures. Operating element 22a, 22b is arranged, in particular, on first side 25a, 25b. The two actuating elements 20a, 20b are, in particular, structurally identical.

According to the invention, the two actuating elements 20a, 20b are arranged relative to one another in such a way that the two operating elements 24a, 24b are arranged on sides 25a, 25b of the base elements 24a, 24b facing away from one another. The other two sides 26a of base elements 24a, 24b are, in particular, arranged facing one another. The two actuating elements 20a, 20b are, in particular, arranged at a distance A from one another.

The actuating elements 20a, 20b are, in particular, arranged relative to one another in such a way that the longitudinal axes L1, L2 of the two operating elements 24a, 24b are arranged parallel to one another and, in particular, coincide (cf. FIG. 2).

The actuating element 20a, 20b, in particular the operating element 24a, 24b, can be coupled to an actuator (not shown), in particular a vibration motor, in order to be able to provide haptic feedback to the operating element 24a, 24b when actuated by a user.

For each of the actuating elements 20a, 20b, an individual force F1, F2 can be determined, in at least three spatial directions, in particular at least in the three linear spatial directions X, Y, Z, preferably additionally in the direction of rotation Mz about the longitudinal axis L1, L2 of the operating element 24a, 24b, from the relative movement between operating element 22a, 22b and base element 24a, 24n.

Device 10 further comprises an evaluation/control unit 30, which records the individual force F1, F2 determined by each actuating element 20a, 20b, and which is designed to calculate, in at least three spatial directions, in particular the three linear spatial directions Fx, Fy, Fz, but preferably in all six spatial directions Fx, Fy, Fz, Mx, My, Mz, the force acting on the body from the two individual forces F1, F2. The calculation can be made, for example, based on the sum of the individual forces F1, F2, in particular, taking into account the distance A between the two actuating elements 20a, 20b. Even if each individual actuating element 20a, 20b determines an individual force F1, F2 in less than six spatial directions, due to the fact that two actuating elements 20a, 20b are used and these are arranged at a distance from one another, an overall calculation of the force F acting on the body can also be carried out in all six spatial directions Fx, Fy, Fz, Mx, My, Mz.

The evaluation/control unit can also be designed to calculate, in at least three spatial directions, preferably in all six spatial directions Fx, Fy, Fz, Mx, My, M, the force acting between the two actuating elements 20a, 20b based on the individual forces F1, F2, in particular, from the difference between the individual forces F1, F2, also taking into account in the process the distance A of the actuating elements 20a, 20b. The force acting between the two actuating elements 20a, 20b can be used, for example, to switch a dead man's switch 40. The dead man's switch 40 can be used, for example, to detect whether a user is touching the actuating elements 20a, 20b, and only in this case activate a learning process or a programming process. If the pressure is too low or too high, the dead man's switch 40 can stop or prevent a movement of the body.

The actuating elements 20a, 20b and the evaluation/control unit 30 can be arranged in a housing 50, which can be detachably arranged on a body. In this case, the operating elements 22a, 22b are accessible from outside housing 50 to enable operation. The operating elements 22a, 22b are arranged in this case in particular on two opposite sides 51, 52 of the surface of housing 50. Housing 50 can be fastened by means of a fastening device such as, for example, screws, magnets, snap connections or the like.

FIGS. 3 and 4 show an arrangement of device 10 on a tool holder 60, which can be arranged, for example, as shown in FIGS. 5 and 6, on a robot head 72 of a robot arm 70. Robot arm 70 can be a robot arm 70 of an industrial robot or of a collaborative robot, a so-called cobot.

Such a device 10 enables a user to teach a movement of robot arm 70 in a simple manner by gripping in the area of the free end of robot arm 70, in particular on robot head 72, there in particular on tool holder 60, and guiding robot arm 70 in the desired directions, since device 10 determines the force applied by the user and acting on robot arm 70 and can convert it into control signals after the teaching process in order to be able to trace the movement automatically.

The embodiment shown in FIGS. 7 and 8 differs from the previously described embodiment only in that device 10 is not detachably arranged on tool holder 60, but is integrated into tool holder 60, i.e., is arranged in the same housing. Alternatively, it would also be possible to integrate device 10 into robot head 72 or elsewhere on robot arm 70, with an arrangement of device 10 as far away as possible from the rotation or swivel axes of robot arm 70 being preferred in order to be able to keep the forces required to move robot arm 70 low due to the longer lever.

### LIST OF REFERENCE NUMERALS

10 Device
20a Actuating element
20b Actuating element
22a Operating element
22b Operating element
24a Base element
24b Base element
25a Side
25b Side
26a Side
30 Evaluation/control unit
40 Dead man switch
50 Housing
60 Tool holder
70 Robot arm
72 Robot head
A Distance
L1 Longitudinal axis
L2 Longitudinal axis

1. A device (10) for determining, in at least three spatial directions (Fx, Fy, Fz, Mx, My, Mz), a force acting on a body, in particular a manipulator, having
two actuating elements (20a, 20b), each of the actuating elements (20a, 20b) having an operating element (22a, 22b) with a longitudinal axis (L1, L2) which is movable, in particular tiltable, relative to a base element (24a, 24b), an individual force (F1, F2) being able to be determined, in at least three spatial directions, from the relative movement between the operating element (22a, 22b) and the base element (24a, 24b), and the two actuating elements (20a, 20b) being arranged relative to one another in such a way that the two operating elements (22a, 22b) are arranged on sides (25a, 25b) of the base elements (24a, 24b) facing away from one another,
and an evaluation/control unit (30), which records the individual force (F1, F2) determined by each actuating element (20a, 20b), and which is designed to calculate, in at least three spatial directions (Fx, Fy, Fz, Mx, My, Mz), the force acting on the body from the two individual forces (F1, F2), in particular, from the sum of the individual forces.

2. The device according to claim 1,
characterized in that an individual force (F1, F2) can be determined, in at least four spatial directions (Fx, Fy, Fz, Mx, My, Mz), from the relative movement between the operating element (22a, 22b) and the base element (24a, 24b), in particular, in the three linear spatial directions and in the direction of rotation about the longitudinal axis (L1, L2) of the operating element (22a, 22b).

3. The device according to claim 1,
characterized in that the evaluation/control unit (30) is designed to calculate, in six spatial directions (Fx, Fy, Fz, Mx, My, Mz), the force acting on the body from the two individual forces (F1, F2), in particular, from the sum of the individual forces.

4. The device according to claim 1,
characterized in that the two base elements (24a, 24b) are arranged at a distance (A) from one another.

5. The device according to claim 1,
characterized in that the actuating elements (20a, 20b) are designed in the manner of a joystick or trackpoint.

6. The device according to claim 1,
characterized in that the evaluation/control unit (30) is designed to calculate, in at least three spatial directions (Fx, Fy, Fz, Mx, My, Mz), the force acting between the two actuating elements (20a, 20b) on the basis of the individual forces (F1, F2), in particular, from the difference between the individual forces.

7. The device according to claim 1,
characterized in that the device (10) has a dead man's switch (40), which switches depending on the force acting between the two actuating elements (20a, 20b).

8. The device according to claim 1,
characterized in that the actuating element (20a, 20b), in particular the operating element (22a, 22b), is coupled to an actuator, in particular a vibration motor.

9. A body, in particular a manipulator, preferably an industrial robot or cobot, having a device (10) according to claim 1.

10. The body according to claim 9,
characterized in that the two actuating elements (20a, 20b) are arranged relative to one another on the surface of the body in such a way that their longitudinal axes (L1, L2) are arranged parallel to one another.

11. The body according to claim 9,
characterized in that the device (10) is detachably arranged on the body.

12. The body according to claim 9,
characterized in that the two actuating elements (20a, 20b) are arranged on two sides of the surface of the body facing away from one another.
